(19) United States
(12) Patent Application Publication
(10) Pub. No.: US 2002/0182443 A1
(43) Pub. Date: Dec. 5, 2002

(54) Substrate for perpendicular magnetic recording medium, perpendicular magnetic recording medium using the substrate, and method of manufacturing

(76) Inventor: Keiji Ohkubo, Nagano (JP)

Correspondence Address: ROSSI & ASSOCIATES, P.O. Box 826, Ashburn, VA, 20146-0826, US

(21) Appl. No.: 10/128,540

(22) Filed: Apr. 23, 2002

(30) Foreign Application Priority Data
Apr. 23, 2001 (JP) JP2001-124798

(51) Int. Cl. G11B 5/82

(52) U.S. Cl. 428/694 SG

(57) ABSTRACT

A substrate for a perpendicular magnetic recording medium provides an increase in the recording density of a magnetic layer of the substrate without increasing the recorded track width, with the skew angle of the magnetic pole of a magnetic recording head varied. The surface of the substrate is grooved in concentric circles to provide a land and a groove alternated with each of the land and the groove arranged at regular intervals. The total of land width and groove width is equal to the track pitch of a magnetic recording head used in magnetic recording. The land widths are less than or equal to the effective recorded track width of the magnetic recording head, and the grooves have depths 200 nm or more.

### FIELD OF THE INVENTION

This invention relates in general to a substrate for a perpendicular magnetic recording medium, a perpendicular magnetic recording medium utilizing the substrate, and a method of manufacturing them. More specifically, the invention provides a high recording density without increasing the recorded track width.

### BACKGROUND OF THE INVENTION

Perpendicular magnetic recording medium are classified roughly into two sorts of media, namely a single-layer type and a double-layer type, from the structure of a magnetic layer formed on a substrate. The single-layer type comprises a singleperpendicular magnetic recording layer only. The double-layer type comprises a double-layered magnetic layer consisting of a perpendicular magnetic recording layer and a back layer including a soft magnetic layer. Information is written onto and read out from these perpendicular magnetic recording media with magnetic recording heads with a ring type thin film magnetic recording head applied in longitudinal magnetic recording and a single-pole magnetic recording head. This requires strengthening the perpendicular magnetization of these heads so as to conform to the perpendicular magnetic recording, There are limits, however, to strengthening the perpendicular magnetic field of these heads for their proper adaptability to the longitudinal magnetic recording. Thus, limitations in the measures taken to deal with magnetic recording heads require the magnetic recording medium of a structure enabling improved perpendicular magnetic recording. The double-layer type perpendicular magnetic recording medium with the back layer for enhancing the effect of head magnetic field on the magnetic recording layer, is becoming the main stream from such a viewpoint.

Further, it is necessary to improve linear density and track density to improve area density in the perpendicular magnetic recording medium. Linear density refers to density in the circumferential direction of the recording medium, and track density refers to density in the radial direction of the recording medium. Increasing both densities improves effectively area density because both contribute to the area density. However, the current ratio of linear densities to track densities is 12 to 1, and high area density depends on mostly to linear density. Thus, it is indispensable to increase track density, that is density in the radial direction of the recording medium, in order to achieve greater area density.

Then, methods to improve track density have to be devised. First, the magnetic pole width of a corresponding magnetic recording head is narrowed. Recorded track width, the size of a recorded track in the radial direction, is narrowed as a result of the narrowed magnetic pole, improving track density. As shown in FIG. 8(a), a track 20 is part of a medium surface, a concentric circle of prescribed width, altered magnetically with a magnetic pole 14 of a magnetic recording head.

At a prescribed position, the magnetic pole 14 of the magnetic recording head floats above the rotating perpendicular magnetic recording medium. Skew angle must be taken into account when the recorded track 20 is formed with the head in this way. Skew angle is formed where an outline of the magnetic pole 14 and an outline of a recording section on the recorded track 20 cross each other as shown in FIG. 8(a). Represented is the outline of the magnetic pole 14 by a front edge 18 and a side edge 19, and the outline of the recorded track 20 by borderlines 21 and 22 in the circumferential direction of the track. Interval between the borderline 21 and the borderline 22 corresponds to recorded track width Tw. On condition that the side edge 19 of the magnetic pole 14 and the borderlines 21, 22 of the recorded track cross each other at a skew angle of zero degrees, the width Mw of the magnetic pole 14 parallels the width of a recording section (a recorded bit) 23 on the recorded track 20, that is recorded track width Tw.

However, the magnetic recording head of the conventional hard disk drive (HDD) is often designed to have skew angles −30 to +30 degrees, assuming that the central, internal, and outer circumference of a magnetic disk has a skew angle of zero, a negative, and a positive in degrees respectively. And hence, the magnetic recording head of an actual HDD works above the rotating perpendicular magnetic recording medium with skew angles varied over the range of some −30 to +30 degrees, causing some recorded bits to have a width equal to and others different from magnetic pole width.

Therefore, when the magnetic recording head works with the skew angle of the magnetic pole 14 varied, the recorded track 20 is formed with both the front edge 18 and the side edge 19 in the magnetic pole 14 as shown in FIG. 8(b). That is, the actual recorded track formed by the magnetic pole 14 differs from an interval between two sides of the magnetic pole in width. Nearly equal, however, is the recorded track width to the magnetic pole's diagonal Mw′. As a result, a recorded bit 24 of a distorted polygon is formed as shown in the figure. Larger is recorded track width referred to as effective recorded track width T than width Tw mentioned earlier, making it difficult to achieve high recording density.

Therefore, it would be desirable to offer a substrate for perpendicular magnetic recording, a perpendicular magnetic recording medium using the substrate, and a method of manufacturing the substrate and the medium. Of double layer type is the perpendicular magnetic recording medium, and information is written onto and read out from the medium with a current ring type thin film magnetic recording head and a single-pole magnetic recording head. The substrate, medium, and method of the present invention provide an increase in the recording density of a magnetic recording layer, keeping recorded track width from growing when the magnetic recording head works with the skew angle of the magnetic pole varied.

### SUMMARY OF THE INVENTION

Experiments made to solve the above problems reveal that processing the surface of a substrate as set forth below improves the recording density of a medium's magnetic layer without an increase in recorded track width even when a magnetic recording head works above a rotating medium with the skew angle of the magnetic pole varied. In accordance with the present invention, the substrate is a perpendicular magnetic recording medium of a double-layer type. the surface of the substrate is grooved to provide a land and a groove alternated in respective concentric circles with each of the land and the groove arranged at regular intervals. The total of land width and groove width is equalized with the track pitch of the magnetic recording head used in magnetic recording. The land is formed to have a width which is less than or equal to the effective recorded track width of the magnetic recording head, and the groove has a depth of 200 nm or more.

The present invention is accomplished according to the findings set forth earlier. The substrate for a perpendicular magnetic recording medium of the present invention is characterized by a land and a groove which the surface of the substrate provides. The land and the groove are alternated in respective concentric circles with each of the land and the groove arranged at regular intervals. The total of the land width and the groove width are equal to the track pitch of the magnetic recording head used in magnetic recording. The land width is less than or equal to the effective recorded track width of the magnetic recording head in width, and the groove is 200 nm or more in depth.

Further, the method of manufacturing the substrate for the perpendicular magnetic recording medium of the present invention is characterized by the method of making a land and a groove set forth below. the surface of the substrate is grooved in concentric circles to form grooves 200 nm or more in depth, arranged at regular intervals in the radial direction. Thus, the surface of the substrate is provided with the land and the groove alternated in respective concentric circles, with each of the land and the groove arranged at regular intervals. The land is a flat part between the grooves. The surface of the substrate is grooved in concentric circles to provide the land and groove equal to the track pitch of a magnetic recording head in total width, and the land less than or equal to the effective recorded track width of the magnetic recording head in width.

Further, the perpendicular magnetic recording medium of the present invention is characterized by a seed layer, an antiferromagnetic layer, a soft magnetic layer, an under layer, an intermediate layer, a perpendicular magnetic recording layer, a protective layer, and a lubricative layer formed one on top of another on a non-magnetic substrate mentioned below. The surface of the substrate is provided with a land and a groove alternated in respective concentric circles with each of the land and the groove arranged at regular intervals. The total of land width and groove width is equal to the track pitch of the magnetic recording head. The surface of the substrate is provided with the land less than or equal to the effective recorded track of the magnetic recording head in width, and the groove.

And further, the method of manufacturing a perpendicular magnetic recording medium of the present invention is characterized by making a non-magnetic substrate as set forth below, and by forming a seed layer, an antiferromagnetic layer, a soft magnetic layer, an under layer, an intermediate layer, a perpendicular magnetic recording layer, a protective layer, and a lubricative layer one on top of another on the non-magnetic substrate. The surface of the substrate is grooved in concentric circles to form grooves 200 nm or more in depth, arranged at regular intervals in the radial direction. The surface of the substrate is provided with a land and a groove alternated in respective concentric circles with each of the land and the groove arranged at regular intervals. The land is a flat part between the grooves. The surface of the substrate is grooved in concentric circles to provide the land and groove equal to the track pitch of a magnetic recording head in total width, and the land less than or equal to the effective recorded track width of the magnetic recording head in width.

The substrate is preferably composed of a material selected from the group of ceramic, glass, plastics, and metal including aluminum, titanium, and silicon.

Grooves may be copied from an injection molding stamper onto the surface of a plastic substrate, to provide more than one land and groove.

Further, the surface of a metal substrate and a ceramic substrate is preferably grooved with photolithography to provide more than one land and groove.

Use is made of the more than one land and groove of the perpendicular magnetic recording medium of the present invention to carry ROM information including servo information and confidential information.

### BRIEF DESCRIPTION OF THE DRAWINGS

The invention will now be described with reference to certain preferred embodiments thereof and the accompanying drawings, wherein:

FIG. 1 is a plan view of a substrate for a perpendicular magnetic recording medium referred to in the example of the present invention;

FIG. 2 is a sectional view of a substrate taken as indicated along the line II-II′ of FIG. 1;

FIG. 3 illustrates the relation between the effective recorded track width T of a magnetic pole and skew angle θ referred to in the example;

FIG. 4 is a sectional composition of a perpendicular magnetic recording medium of the present invention;

FIG. 5 is a graph representing amplitude, TAA, and noise in terms of land width referred to in the example;

FIG. 6 is a graph showing the relation between land width and SN ratio referred to in the example;

FIG. 7 is a graph showing the relation between groove depth and effective recorded track width referred to in the example; and

FIG. 8 illustrates the relation between skew angle of a magnetic pole in a conventional magnetic recording head and recorded track width formed by the head, FIG. 8 (a) illustrates that when the magnetic pole has a skew angle of zero degrees, and FIG. 8 (b) skew angles more than zero degrees.

### DETAILED DESCRIPTION OF THE PREFERRED EMBODIMENTS

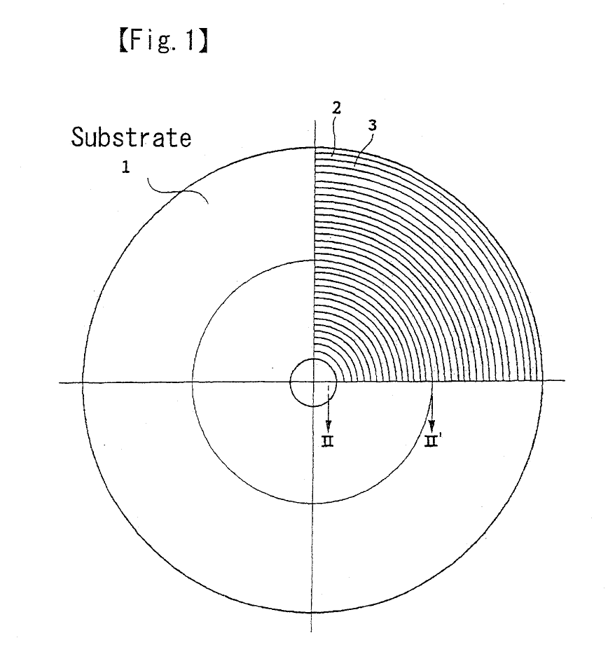

The following describes a preferred embodiment of the present invention with reference to accompanying drawings. FIG. 1 is a typical chart referring to the example of a substrate for a perpendicular magnetic recording medium of the present invention.

The surface of the substrate 1 is provided with more than one groove of prescribed depth in concentric circles at regular intervals. Thus, provided is the surface of the substrate 1 with the land 3 and the groove 2 alternated in concentric circles with each of them arranged at regular intervals. The land is a flat part between the grooves.

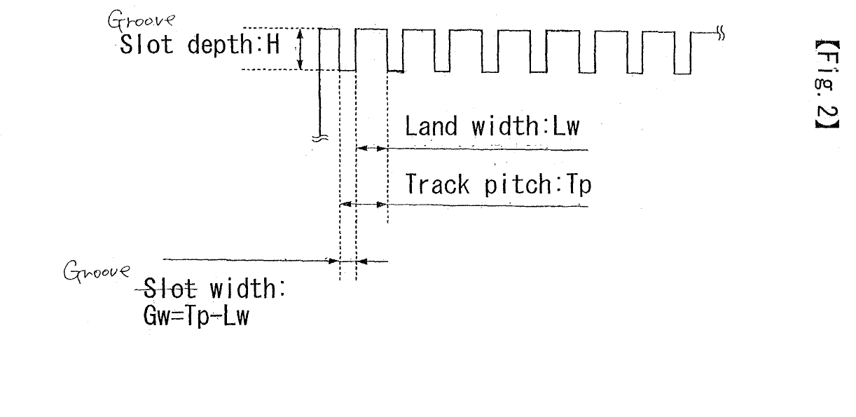

FIG. 2 is a sectional view of a substrate taken as indicated along the line II-II′ of FIG. 1. The depth of groove 2 is represented by H, groove width is Gw, the land width of land 3 is represented by Lw, and track pitch is Tp as shown in the figure.

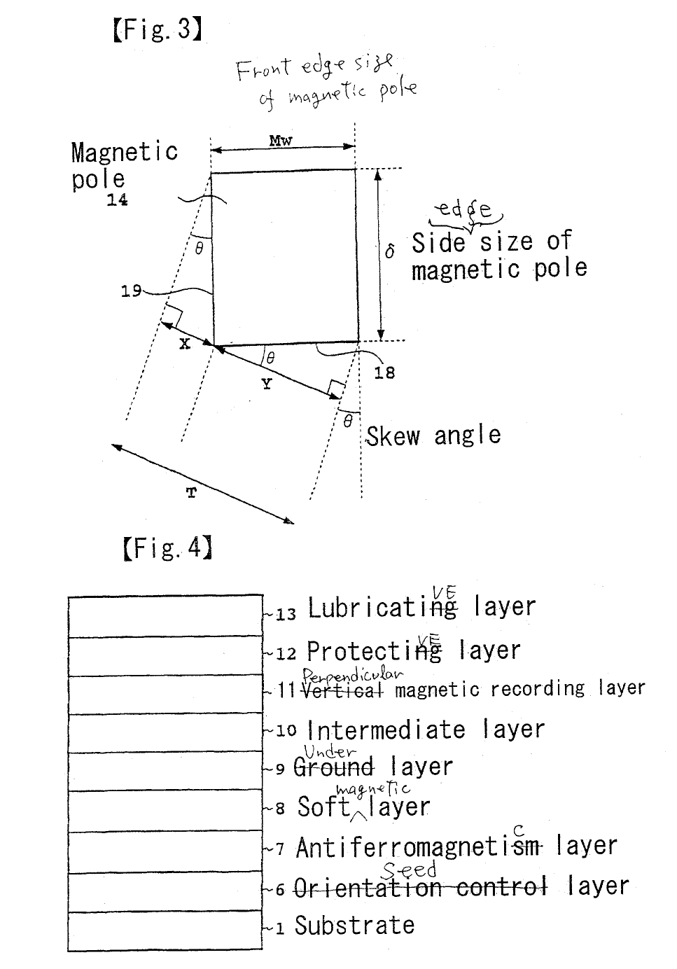

Further, FIG. 3 is a illustrates the relation between the effective recorded track width T of a magnetic pole and skew angle θ. Recorded track width, referred to as effective recorded track width, T equals the track width Y of the front edge 18 plus the track width X of the side edge 19 in a magnetic pole 14, when skew angle θ is larger than zero degrees as shown in FIG. 3.

The total of groove width Gw and land width Lw equal to track pitch Tp. Effective recorded track width T formed by the head of a recording medium is given in terms of skew angle θ of the magnetic pole 14 of a magnetic recording head.

It follows that, the effective recorded track width, T, is calculated as follows:

T=X+Y=δ sin θ+Tw cos θ,

Wherein δ represents the side edge dimension of the magnetic pole and Tw is recorded track width. The recorded track width Tw, which is equal to magnetic pole width Mw, is reduced to the effective recorded track width T when the magnetic pole has a skew angle θ of zero degrees.

As is apparent from the foregoing equation, the larger the skew angle θ of the magnetic recording head, the wider is the effective recorded track width, T. For instance, assuming a linear density of 1000 KBPI and a track density of 100 kTPI for an area density of 100 Gb/in^{2,} track pitch, which implies an adjacent track interval, Tp results in 0.254 μm. Then, track pitch Tp of 0.254 μm provides the magnetic pole 14 of a magnetic recording head with a magnetic pole width Mw of 0.216 μm, magnetic pole width Mw is equal to some 85 percent of track pitch. Hence, the land 3, which is the flat part between grooves of the substrate 1, is formed to have land widths Lw of 0.216 μm or less, and groove 2 to have groove widths Gw of 0.038 μm or more.

Width Gw of groove 2 has relation to width Lw of land 3 as set forth below. It follows that, land width Lw and groove width Gw are calculated as follows:

Lw(μm)≦25.4 /A*1000*B,

and

groove width Gw (μm)=Tp−Lw≧25.4/A*1000*(1−B),

wherein A(kTPI) is track density, and B is the distribution ratio of land width Lw to groove width Gw under prescribed track pitch Tp.

As mentioned earlier, the magnetic recording head in a HDD is conventionally designed to have skew angles −30 to +30 degrees, assuming that the central, internal, and outer circumference of a magnetic disk, that is a magnetic recording medium, which the recording head floats over, provides a skew angle of zero, a negative, and a positive in degrees respectively. The polarity of the skew angle has no effect on effective recorded track width, and a skew angle of −30 degrees and +30 degrees gives the same effective recorded track width under skew angles of −30 to +30 degrees. Hence, it is appropriate to design land width Lw and groove width Tp-Lw with a large absolute value of skew angle θ. The following describes the method of forming the land and the groove of a substrate with land width Lw and groove width Tp-Lw designed in this way under prescribed track density.

The substrate is preferably composed of molded plastic, etched metal carbon or ceramic, or etched and melted glass.

The molded plastic substrate is formed by injection molding. The substrate is preferably composed of polycarbonate, polyolefine, or polyimide The injection molding stamper is patterned in advance with land width Lw and groove width Tp-Lw designed as set forth earlier. Grooves and lands are copied from the stamper to the surface of the substrate.

To form the etched substrate, photo-resist 1 μm thick is applied to the surface of a substrate which is preferably composed of metal including Al, Al/NiP, Ti, and Si; carbon; or ceramic such as Al₂O₃. The substrate is masked, exposed, and developed to provide photo-resist of a prescribed pattern. The surface of the substrate is grooved by reactive ion etching (RIE) of the processed substrate with a mixed gas of argon and chlorofluorocarbon, for example CClF₃. The substrate is provided with a land and a groove by exfoliating the patterned photo-resist.

To form the glass substrate, the photolithography technique used in the metal substrate and the ceramic substrate, and the melt process used in the plastics substrate can be applied to the formation of a glass substrate with a land and a groove. Glass is melted at temperatures of 700 to 800.

The land and the groove can store patterned ROM information as well as recording data. ROM information includes servo information on the address of record data, and confidential information for protecting copyright. Thus, the medium with the land and the groove can be used as a magnetic recording medium with high recording density and security.

The following describes a preferred method of manufacturing a perpendicular magnetic recording medium of a double type by utilizing these substrates. A plastic substrate is degassed in a vacuum oven. Then, the plastic substrate is put in a vacuum chamber, and the vacuum chamber is pumped to 10⁻⁵ Pa or less. The following layers are formed on the unheated substrate 1: an orientation control layer 6, an antiferromagnetic layer 7, a soft magnetic layer 8, an under layer 9, a non-magnetic intermediate layer 10, a perpendicular magnetic recording layer 11, and a protective layer 12 one on top of another with DC magnetron sputtering technique as shown in FIG. 4. The single-layered or multi-layered orientation control layer 6, the back layer, is preferably composed of Ta, Cu, NiFeCr, etc. The antiferromagnetic layer 7 is preferably composed of IrMn, NiMn, PtMn, etc. The soft magnetic layer 8 is preferably composed of CoZrNb, CoZrTa, CoFeNi, FeCo, etc. In addition, the under layer 9 is preferably composed of Ti, TiCr, Pd, Ru, etc. The non-magnetic intermediate layer 10 is preferably composed of CoCr, CoCrTa, CoCrRu, etc. The perpendicular magnetic recording layer 11 is preferably composed of CoCrPt, CoCrPtB, ThCo, TbFeCo, ThCoCr, TbFeCoCr, etc. The protective layer 12 is preferably composed of DLC carbon, nitrogenous carbon, etc. The substrate is taken out of the vacuum chamber, and a lubricative layer 13 is formed by applying fluorocarbon polymer, tetraol, etc. to provide the perpendicular magnetic recording medium of a double-layer type. Each layer optimized in layer thickness is formed according to the condition that each layer material dictates.

Alternatively, the substrate may be formed with any of the following techniques: DC sputtering, RF magnetron sputtering, face-to-face target type sputtering, ECR sputtering, ion beam sputtering (IBS), and CVD to provide characteristics similar to that obtained with the DC magnetron sputtering technique.

In another preferred embodiment, a metal, glass, and ceramic substrate is heated, and layers similar to those in plastics substrate were formed to provide a perpendicular magnetic recording medium of a double-layer type.

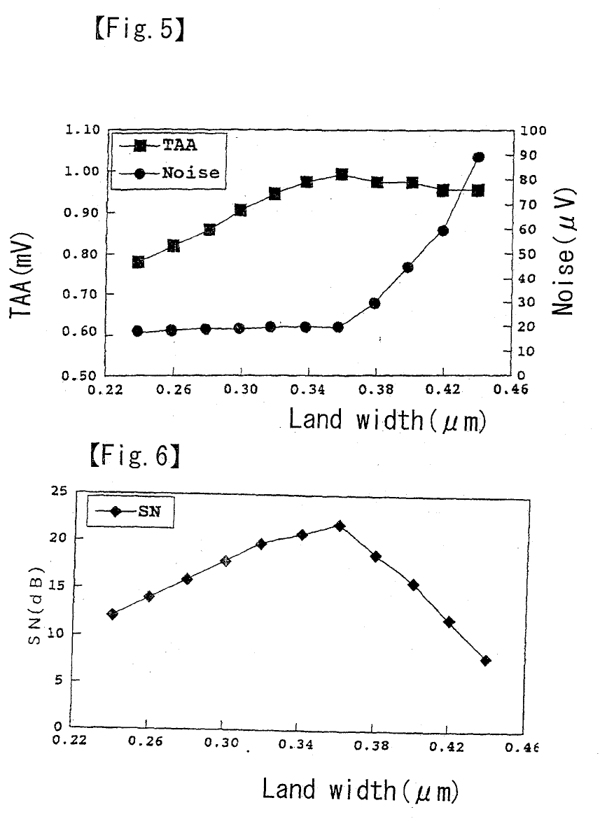

FIG. 5 is a graph representing amplitude TAA and noise in terms of land width. The magnetic recording head has a magnetic pole width of 0.36 μm, a side edge size of 0.30 μm, a skew angle of 30 degrees, and a track density of 60 kTPI. Measurement demonstrates that land widths which are greater than or equal to the magnetic pole width of 0.36 μm increase noise considerably. This is ascribed to an increase in recorded track width of a recorded bit, the formation of a polygon recorded bit, the influence of adjacent recorded tracks, etc. Further, land widths less than the magnetic pole width of 0.36 μm slightly diminish noise. Amplitude, TAA, on the contrary, decreases due to the reduction of recorded magnetization.

FIG. 6 is a graph showing the relation between land width and SN ratio. Measurement indicates that land widths from 0.32 to 0.36 μm are required in order to obtain SN ratios 20 dB or more. Land widths should be minimized so that they are less than or equal to magnetic pole width, and optimized according to the kind of a magnetic recording head used and medium characteristic.

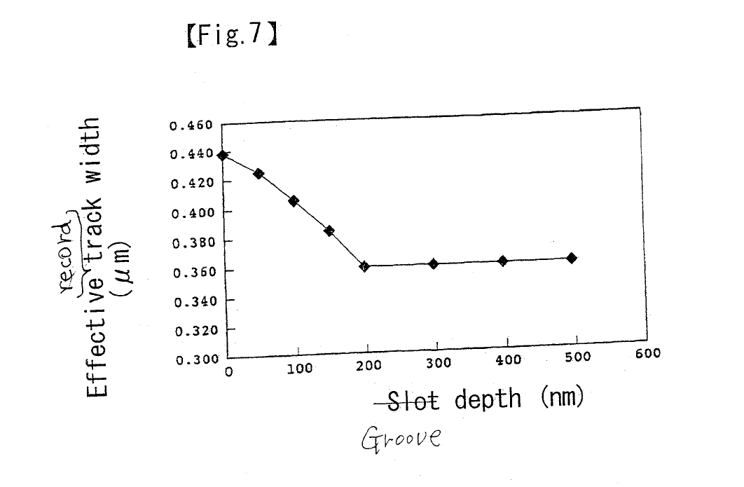

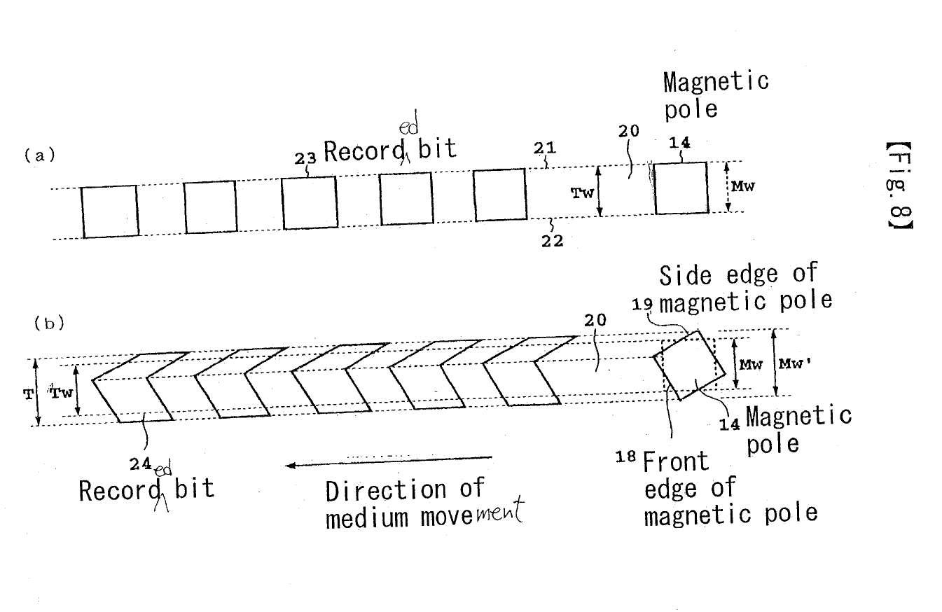

FIG. 7 is a graph showing the relation between groove depth and effective recorded track width. The magnetic recording head has a skew angle of 20 degrees, with other conditions remaining the same. Measurement reveals that a shallow groove depth causes the signal recorded in grooves to be detected, increasing effective recorded track width. Groove depths 200 nm or more results in an effective recorded track width equal to magnetic pole width 0.36 μm. Hence, groove widths 200 nm or more suffice.

Findings reveals that land widths from 0.32 to 0.36 μm and groove depths of 200 nm or more in the substrate provide an increase in recording density and an improvement in the RW characteristic (SN ratio≧20 dB) of a perpendicular magnetic recording medium, assuming that the magnetic recording head has a magnetic pole width of 0.36 μm, a magnetic pole's side edge size of 0.30 μm, a skew angle of 30 degrees, and a track density of 60 kTPI.

A perpendicular magnetic recording medium with high recording density and an excellent RW characteristic can be efficiently manufactured with the present inventions as set forth above.

What is claimed is:

1. A substrate for a perpendicular magnetic recording medium comprising:
a land; and
a groove;
wherein said land and groove are alternated in respective concentric circles with each of said land and groove arranged at regular intervals;
wherein said land and groove are equal to the track pitch of said magnetic recording head in total width;
wherein said land is less than or equal to the effective recorded track width of said magnetic recording head in width; and
wherein said groove is 200 nm or more in depth.

2. A substrate for a perpendicular magnetic recording medium as set forth in claim 1, wherein said substrate is composed of at least one of metal, including aluminum, titanium, and silicon, ceramic, glass, and plastics.

3. A method for manufacturing a substrate for a perpendicular magnetic recording medium comprising the steps of:
(a) grooving the surface of said substrate in concentric circles to provide a land and a groove;
wherein said land and groove are alternated in respective concentric circles with each of said land and groove arranged at regular intervals;
wherein said land and groove are equal to the track pitch of said magnetic recording head in total width;
wherein said land is less than or equal to the effective recorded track width of said magnetic recording head in width; and
wherein said groove is 200 nm or more in depth.

4. A method for manufacturing a substrate for a perpendicular magnetic recording medium as set forth in claim 3, wherein said substrate is composed of at least one of metal, including aluminum, titanium, and silicon, ceramic, glass, and plastics.

5. A method for manufacturing a substrate for a perpendicular magnetic recording medium as set forth in claim 3, wherein the surface of a plastic substrate is grooved by copying more than one land and groove from an injection molding stamper onto said substrate.

6. A method for manufacturing a substrate for a perpendicular magnetic recording medium as set forth in claim 3, wherein the surface of a ceramic or a metal substrate is grooved by photolithography to provide more than one land and groove.

7. A perpendicular magnetic recording medium including a substrate and a perpendicular magnetic recording layer comprising:
a land of said substrate; and
a groove of said substrate;
wherein said land and groove are alternated in respective concentric circles with each of said land and groove arranged at regular intervals, said land and groove are equal to the track pitch of said magnetic recording head in total width, said land is less than or equal to the effective recorded track width of said magnetic recording head in width, and said groove is 200 nm or more in depth.

8. A perpendicular magnetic recording medium as set forth in claim 7, wherein a substrate is composed of one selected from the group of metal, including aluminum, titanium, and silicon, ceramic, glass, and plastics.

9. A perpendicular magnetic recording medium as set forth in claim 7, wherein ROM information, including servo information and confidential information, is formed with more than one land and groove.

10. A method for manufacturing a perpendicular magnetic recording medium including a seed layer, an antiferromagnetic layer, a soft magnetic layer, an under layer, an intermediate layer, a perpendicular magnetic recording layer, a protective layer, and a lubricative layer formed one on top of another on a non-magnetic substrate comprising the steps of:
(a) grooving the surface of said substrate in concentric circles to provide a land and a groove;
wherein said land and groove are alternated in respective concentric circles with each of said land and groove arranged at regular intervals;
wherein said land and groove are equal to the track pitch of a magnetic recording head in total width;
wherein said land is less than or equal to the effective recorded track width of said magnetic recording head in width; and
wherein said groove is 200 nm or more in depth.

11. A method for manufacturing a perpendicular magnetic recording medium as set forth in claim 10, wherein a substrate is composed of at least one of metal, including aluminum, titanium, and silicon, ceramic, glass, and plastics.

12. A method for manufacturing a perpendicular magnetic recording medium as set forth in claim 10, wherein the surface of a plastic substrate is grooved by copying more than one land and groove from an injection molding stamper onto said substrate.

13. A method for manufacturing a perpendicular magnetic recording medium as set forth in claim 10, wherein the surface of a ceramic or a metal substrate is grooved by photolithography to provide more than one land and groove.
